(19) United States
(12) Patent Application Publication
(10) Pub. No.: US 2020/0294490 A1
(43) Pub. Date: Sep. 17, 2020

(54) METHOD, APPARATUS, SYSTEM, AND ELECTRONIC DEVICE FOR VOICE CONTROLLING SMART HOME ELECTRICAL APPLIANCE

(71) Applicants: GREE ELECTRIC APPLIANCES (WUHAN) CO., LTD, Wuhan (CN); GREE ELECTRIC APPLIANCES, INC.OF ZHUHAI, Zhuhai (CN)

(72) Inventors: Jing WANG, Zhuhai (CN); Liang ZHANG, Zhuhai (CN); Xinchao PENG, Zhuhai (CN); Yijun XU, Zhuhai (CN); Yuming FENG, Zhuhai (CN); Xiaoning BAI, Zhuhai (CN); Yuhua XIE, Zhuhai (CN); Huiping YIN, Zhuhai (CN); Cong WANG, Zhuhai (CN)

(73) Assignees: GREE ELECTRIC APPLIANCES (WUHAN) CO., LTD, Wuhan (CN); GREE ELECTRIC APPLIANCES, INC.OF ZHUHAI, Zhuhai (CN)

(21) Appl. No.: 16/651,217

(22) PCT Filed: Aug. 14, 2018
(86) PCT No.: PCT/CN2018/100495

§ 371 Date: Mar. 26, 2020

(30) Foreign Application Priority Data
Nov. 9, 2017 (CN) 201711098148.3

(51) Int. Cl. G10L 15/08; H04L 12/28; H04L 29/08

(52) U.S. Cl. CPC G10L 15/08; G10L 2015/088; H04L 67/125; H04L 12/282

(57) ABSTRACT

The embodiments of the present disclosure relate to a technical field of home electrical appliances, and particularly to methods, apparatus, systems, and electronic devices for voice controlling a smart home electrical appliance. The method includes: acquiring speech information of a user; performing a recognition on the speech information to acquire a control command; determining a target home electrical appliance according to the control command, and transmitting the control command to the target home electrical appliance; and acquiring a first execution result sent back from the target home electrical appliance, wherein the first execution result represents a state of the target home electrical appliance.

### CROSS REFERENCE TO RELATED APPLICATIONS

This application is a National Stage of International Application No. PCT/CN2018/100495, filed Aug. 14, 2018 which claims priority to Chinese Patent Application No. 201711098148.3, filed on Nov. 9, 2017, and entitled “METHOD, APPARATUS, SYSTEM, AND ELECTRONIC DEVICE FOR VOICE CONTROLLING SMART HOME ELECTRICAL APPLIANCE”, the content of which are hereby incorporated by reference in its entirety.

### TECHNICAL FIELD

The embodiments of the present disclosure relate to a technical field of home electrical appliances, and particularly to methods, apparatus, systems, and electronic devices for voice controlling smart home electrical appliances.

### BACKGROUND

At present, with the rapid development of science and technology as well as the national economy, home electrical appliances have been becoming more intelligence so as to meet users' growing requirements. Since a prevailing control method for the home electrical appliance is realized by controlling a button on the appliance or via an infrared remote control specifically matched with the appliance, and the user must stop doing other things and walk to the home electrical appliance or find the remote control to control the operation state of the home electrical appliance, which is far less convenient than the means of voice control. Therefore, a method for voice controlling home electrical appliances is emerging.

However, the inventors of the present disclosure found the following problems in prior art while accomplishing the present disclosure. In prior art, although a voice control module is integrated on the appliance body to implement the voice control for most home electrical appliances with voice control functions, the appliance only responds to a face-to-face voice command from the user standing near the appliance. Therefore, the voice control of the appliance has a regional restriction. The control command cannot be accurately recognized when the user and the appliance are too far away from each other. Therefore, there is a need to provide a method and a system that can control any one of home electrical appliances which are connected to a network in the home through the voice command at any one of corners of the home, to ensure that the voice control process will not be affected by the distance between the user and the appliance.

### SUMMARY

In a first aspect, a technical solution adopted by the embodiments of the present disclosure is to provide a method for voice controlling a smart home electrical appliance, including:

acquiring speech information of a user;

performing a recognition on the speech information to acquire a control command;

determining a target home electrical appliance according to the control command, and transmitting the control command to the target home electrical appliance; and

acquiring a first execution result sent back from the target home electrical appliance, wherein the first execution result represents a state of the target home electrical appliance.

Optionally, the method further includes:

determining whether the control command is successfully executed according to the first execution result;

forwarding the control command to a central server when it is determined that the control command is not successfully executed according to the first execution result, such that the central server transmits the control command to the target home electrical appliance; and

acquiring a second execution result sent back from the target home electrical appliance, wherein the second execution result represents the state of the target home electrical appliance.

Optionally, the method further includes:

receiving a malfunction analysis result, wherein the malfunction analysis result is formed from a malfunction analysis on the target home electrical appliance when the central server determines that the control command is not successfully executed according to the second execution result.

Optionally, before the step of acquiring the speech information of the user, the method further includes:

acquiring information of each smart home electrical appliance stored in the central server, wherein the information of the each smart home electrical appliance includes a name of the smart home electrical appliance.

Optionally, the method further includes receiving successful execution information, wherein the successful execution information is sent back from the central server when the central server determines that the control command is successfully executed according to the second execution result.

Optionally, the step of performing the recognition on the speech information to acquire the control command includes:

performing the recognition on the speech information to determine keyword information in the speech information, wherein the keyword information includes a name of the target home electrical appliance and an action to the target home electrical appliance; and

generating the control command according to the keyword information.

In a second aspect, another technical solution adopted by the embodiments of the present disclosure is a method for voice controlling a smart home electrical appliance, including:

transmitting a control command to a target home electrical appliance;

receiving a second execution result sent back from the target home electrical appliance, wherein the second execution result represents a state of the target home electrical appliance;

determining whether the control command is successfully executed according to the second execution result;

when it is determined that the control command is not successfully executed, performing a malfunction analysis on the target home electrical appliance to form a malfunction analysis result; and

transmitting the malfunction analysis result to a mobile terminal of the user.

Optionally, the method further includes:

when it is determined that the control command is successfully executed, forming successful execution information and transmitting the successful execution information to the mobile terminal of the user.

Optionally, prior to the step of transmitting the control command to the target home electrical appliance, the method further includes:

receiving the control command.

In a third aspect, another technical solution adopted by the embodiments of the present disclosure is an apparatus for voice controlling a smart home electrical appliance, including:

an acquisition module, configured to acquire speech information of a user;

a recognition module, configured to perform a recognition on the speech information to acquire a control command;

a first transmission module, configured to determine a target home electrical appliance according to the control command, and transmit the control command to the target home electrical appliance; and

a first receiving module, configured to acquire a first execution result sent back from the target home electrical appliance, wherein the first execution result represents a state of the target home electrical appliance.

Optionally, the apparatus further includes:

a first determination module, configured to determine whether the control command is successfully executed according to the first execution result; and

a second transmission module, configured to forward the control command to a central server when it is determined that the control command is not successfully executed according to the first execution result, such that the central server transmits the control command to the target home electrical appliance and receives a second execution result sent back from the target home electrical appliance, wherein the second execution result represents the state of the target home electrical appliance.

Optionally, the apparatus further includes:

a second receiving module, configured to receive a malfunction analysis result, wherein the malfunction analysis result is formed from a malfunction analysis on the target home electrical appliance when the central server determines that the control command is not successfully executed according to the second execution result.

Optionally, the apparatus further includes:

a third receiving module, configured to receive successful execution information, wherein the successful execution information is sent back from the central server when the central server determines that the control command is successfully executed according to the second execution result.

Optionally, the recognition module includes:

a determination unit, configured to perform the recognition on the speech information to determine keyword information in the speech information, wherein the keyword information includes a name of the target home electrical appliance and an action to the target home electrical appliance; and

a command generation unit, configured to generate the control command according to the keyword information.

In a fourth aspect, another technical solution adopted by the embodiments of the present disclosure is an apparatus for voice controlling a smart home electrical appliance, including:

a third transmission module, configured to transmit a control command to a target home electrical appliance;

a fourth receiving module, configured to receive a second execution result sent back from the target home electrical appliance, wherein the second execution result represents a state of the target home electrical appliance;

a second determination module, configured to determine whether the control command is successfully executed according to the second execution result;

a malfunction analysis module, configured to perform a malfunction analysis on the target home electrical appliance and form a malfunction analysis result when it is determined that the control command is not successfully executed; and

a fourth transmission module, configured to transmit the malfunction analysis result to a mobile terminal of the user.

Optionally, the apparatus further includes:

a fifth transmission module, configured to, when it is determined that the control command is successfully executed, form successful execution information and transmit the successful execution information to the mobile terminal of the user.

Optionally, the apparatus further includes:

a fifth receiving module, configured to receive the control command.

In a fifth aspect, another technical solution adopted by the embodiments of the present disclosure is to provide an electronic device, including:

at least one processor; and

a memory connected to the at least one processor, wherein the memory is configured to store operation instructions executed by the at least one processor, and the processor executes any one of above-mentioned methods while the operation instructions being executed.

In a sixth aspect, another technical solution adopted by the embodiments of the present disclosure is to provide a system for voice controlling a smart home electrical appliance, characterized in that the system includes a mobile terminal, the smart home electrical appliance, and a central server. The mobile terminal is connected to the smart home electrical appliance. The central server is respectively connected to the mobile terminal and the smart home electrical appliance.

The mobile terminal is configured to acquire speech information of a user, perform a recognition on the speech information to acquire a control command, determine a target home electrical appliance from the smart home electrical appliance according to the control command, and transmit the control command to the target home electrical appliance. The mobile terminal is configured to acquire a first execution result sent back from the target home electrical appliance. The first execution result represents a state of the target home electrical appliance. The mobile terminal is configured to determine whether the control command is successfully executed according to the first execution result. When it is determined that the control command is not successfully executed according to the first execution result, the mobile terminal is configured to forward the control command to the central server.

The central server is configured to transmit the control command to the target home electrical appliance and receive a second execution result sent back from the target home electrical appliance. The second execution result represents the state of the target home electrical appliance. The central server is configured to determine whether the control command is successfully executed according to the second execution result. When it is determined that the control command is not successfully executed according to the second execution result, the central server is configured to perform a malfunction analysis on the target home electrical appliance and form a malfunction analysis result, and then transmit the malfunction analysis result to the mobile terminal. When it is determined that the execution of the control command is successful according to the second execution result, the central server is configured to send back successful execution information to the mobile terminal.

The embodiments of the present disclosure have the following beneficial effects. In contrast of prior art, in the embodiments of the present disclosure, the method for voice controlling a smart home electrical appliance includes: acquiring speech information of a user; performing a recognition on the speech information to acquire a control command; determining a target home electrical appliance according to the control command, and transmitting the control command to the target home electrical appliance; and acquiring a first execution result sent back from the target home electrical appliance, wherein the first execution result represents a state of the target home electrical appliance. Therefore, the user can control any one of home electrical appliances which connected to the network in the home through the voice command from any one of corners of the home, thereby improving the control efficiency. In addition, the user can obtain the current state of the target home electrical appliance through the obtained first execution result.

### BRIEF DESCRIPTION OF THE DRAWINGS

FIG. 1 is a schematic structural view of a system for voice controlling smart home electrical appliances according to an embodiment of the present disclosure.

FIG. 2 is a flowchart of a method for voice controlling a smart home electrical appliance according to a first embodiment of the present disclosure.

FIG. 3 is a flowchart of step 102 in the method for voice controlling the smart home electrical appliance according to the first embodiment of the present disclosure.

FIG. 4 is a flowchart of a method for voice controlling a smart home electrical appliance according to a second embodiment of the present disclosure.

FIG. 5 is another flowchart of a method for voice controlling a smart home electrical appliance according to the second embodiment of the present disclosure.

FIG. 6 is a flowchart of a method for voice controlling a smart home electrical appliance according to a third embodiment of the present disclosure.

FIG. 7 is a flowchart of a method for voice controlling a smart home electrical appliance according to a fourth embodiment of the present disclosure.

FIG. 8 is a structural view of an apparatus for voice controlling a smart home electrical appliance according to a fifth embodiment of the present disclosure.

FIG. 9 is a structural diagram of an apparatus for voice controlling a smart home electrical appliance according to a sixth embodiment of the present disclosure.

FIG. 10 is a schematic structural view of a hardware of an electronic device according to an embodiment of the present disclosure.

### DETAILED DESCRIPTION OF THE EMBODIMENTS

The present disclosure will now be described in detail with reference to the accompanying drawings and embodiments in order to make the objects, technical solutions, and advantages thereof more clear and apparent. It should be appreciated that the embodiments described herein are for the purpose of explaining the present disclosure and are not intended to limit the disclosure.

It should be noted that, features in different embodiments of the present disclosure can be combined with each other if there is no conflict between the features, and the combinations of the features are within the protection scope of the present disclosure. In addition, although functional modules are divided and shown in the schematic structural views, and orders of steps are shown in the flowcharts, however, in certain embodiments, the division of the functional modules may be different from that of functional modules shown in the schematic structural views, or the execution of the orders of steps may be different from that of the orders of steps shown or described in the flowcharts.

In order to enable those skilled in the art to better understand the present disclosure, the related technologies in which the present disclosure involved are briefly described below.

A main technical problem solved by the embodiments of the present disclosure is to provide a method, an apparatus, a system, and an electronic device for voice controlling a smart home electrical appliance, to ensure that a user can control any one of home electrical appliances which connected to a network in a home through a voice command at any one of corners of the home, thereby improving the control efficiency.

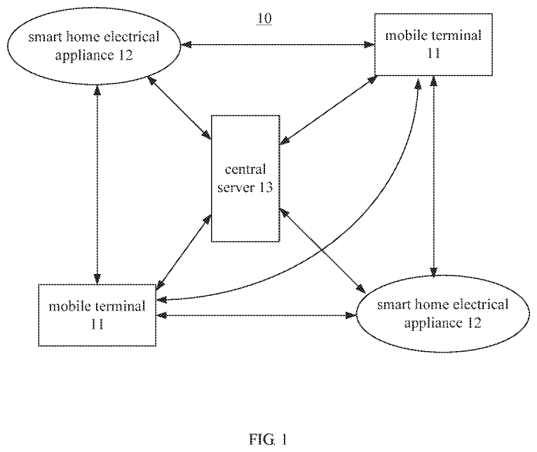

FIG. 1 is a schematic structural view of a system 10 for voice controlling a smart home electrical appliance provided by an embodiment of the present disclosure. Referring to FIG. 1, the system 10 for voice controlling the smart home electrical appliance includes a mobile terminal 11, the smart home electrical appliance 12, and a central server 13.

The mobile terminal 11 includes portable or wearable smart devices such as a mobile phone, a tablet, a smart band, or a smart watch. The number of the mobile terminal 11 can be one or more. Each mobile terminal 11 is configured to have a smart control mode. When the smart control mode is available, the mobile terminal 11 is configured to receive speech information of a user, and configured to recognize a control command from the speech information of the user. The mobile terminal 11 is respectively connected to and capable of interacting information with each of the smart home electrical appliances 12 and the central server 13.

The smart home electrical appliance 12 includes home electrical appliances such as a television, an air conditioner, and a washing machine. The number of the smart home electrical appliance 12 can be one or more. Each smart home electrical appliance 12 can receive the control command sent by the mobile terminal 11 or the central server 13, and be capable of performing an action according to the control command. In addition, each smart home electrical appliance 12 can send a first execution result or a second execution result back to the mobile terminal 11, or can send the first execution result or the second execution result back to the central server 13 after receiving the control command.

The central server 13 can be a server, a server cluster composed of several servers, or a cloud computing service center. The central server 13 belongs to a smart home server for serving a home providing with the smart home electrical appliance and is similar to a network server having a router function. The central server 13 is usually arranged on a central location of the home, to ensure that all smart home electrical appliances 12 in the home are covered by the network. The central server 13 can process the received control command or the second execution result. The central server 13 is connected to each smart home electrical appliance 12 and pre-stores information of each smart home electrical appliance 12. The information of each smart home electrical appliance 12 includes a name, a model, an installation location, and the like corresponding to the smart home electrical appliance 12. Once a new smart home electrical appliance 12 is installed in the home, it is connected with the central server 13 and the information thereof is stored in the central server 13 in time. When there are multiple identical smart home electrical appliances 12, the identical smart home electrical appliances 12 are numbered and renamed, so as to ensure that each smart home electrical appliance 12 has a unique name. The mobile terminal 11 can acquire information of each smart home electrical appliance 12 through the central server 13. The central server 13 can be configured to have a malfunction analysis mode. When the central server 13 determines that the smart home electrical appliance 12 cannot normally execute the control command according to the second execution result, the central server 13 performs a malfunction analysis on the smart home electrical appliance 12 and sends a malfunction analysis result to the mobile terminal 11 of the user. It should be noted that, the mobile terminals 11 can synchronize or share information of the smart home electrical appliance 12 with each other at any time through wireless communication ways, such as but not limited to Bluetooth and WiFi. The communication ways among the mobile terminal 11, the smart home electrical appliance 12, and the central server 13 can be, but are not limited to, wireless communication ways such as infrared, Bluetooth, and WiFi.

The present disclosure will be further described by following various embodiments.

### First Embodiment

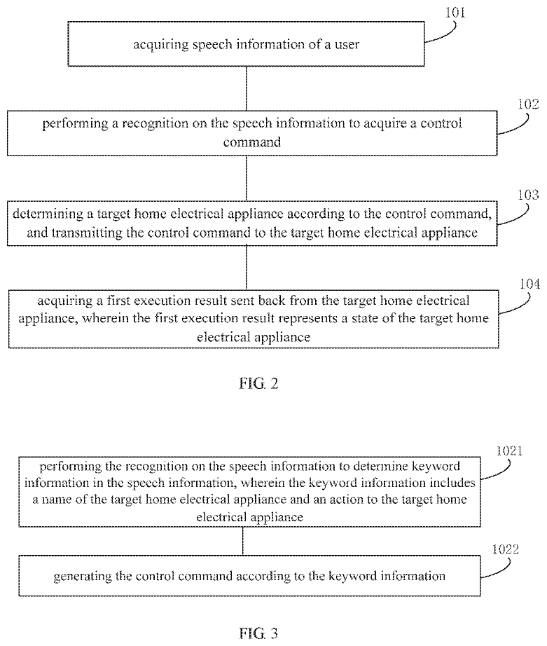

Referring to FIG. 2. in order to solve the above-described technical problem, the first embodiment of the present disclosure provides a method for voice controlling a smart home electrical appliance, including steps 101 and 102.

Step 101: acquiring speech information of a user.

When the smart control mode of the mobile terminal is available, the mobile terminal can acquire the speech information of the user. Optionally, information of each smart home electrical appliance is preset and stored in the central server. The information of each smart home electrical appliance includes information such as the name, the model, and the installation location and the like corresponding to the smart home electrical appliance. Prior to step 101, some embodiments of the method further include acquiring information of each smart home electrical appliance stored in the central server, wherein the information of the smart home electrical appliance includes the name of the smart home electrical appliance.

Step 102: performing a recognition on the speech information to acquire a control command.

After acquiring the speech information of the user, the mobile terminal recognizes the control command from the speech information. Optionally, referring to FIG. 3, and step 102 specifically includes following step 1021 and step 1022.

Step 1021: performing the recognition on the speech information to determine keyword information in the speech information, wherein the keyword information includes a name of a target home electrical appliance and an action to the target home electrical appliance.

Optionally, in this step, the received speech information is firstly converted into text information. The text information is consistent with the speech information and is convenient for recognition and extraction by the mobile terminal. The text information includes the keyword information, wherein the keyword information includes the name of the target home electrical appliance and the action to the target home electrical appliance. For example, the name of the target home electrical appliance includes “TV”, “washing machine”, “air conditioner 1”, “air conditioner 2”, and the like. The action is an action that the user intents to adjust the operation state of each smart home electrical appliance. For example, the action includes “turn on”, “turn off”, “pause”, and the like.

In the first embodiment of the present disclosure, the speech information can be recognized and the keyword information can be acquired by other recognition ways. For example, based on the speech information and a speech database having speeches of keywords preset therein, the words having the same pronunciations as the preset speeches in the speech database can be extracted from the speech information, thereby determining the keyword information from the speech information. The keyword information includes the name of the target home electrical appliance and the action to the target home electrical appliance. The speech database having speeches of keywords preset therein includes preset speeches of keywords, for example, preset speeches for the smart home electrical appliances, such as “air conditioner”, “TV”, “refrigerator”, and the like, and preset speeches for the actions such as “turn on”, “turn off”, “pause”, and the like. Specifically and for example, if the preset speeches of keywords include “refrigerator” and “turn on”, and the extracted words with the same pronunciations also include “refrigerator” and “turn on”, then the “refrigerator” is served as the target home electrical appliance and the “turn on” is served as the action.

Step 1022: generating the control command according to the keyword information.

The keyword information acquired in the previous step can be combined to form the control command. For example, when the received speech information is converted into the text information, and the acquired content of the text is “perform turn on to the air conditioner”, the name of the target home electrical appliance is “air conditioner” and the action is “turn on” in the keyword information. Thus, the generated control command is “turn on air conditioner”.

Step 103: determining a target home electrical appliance according to the control command, and transmitting the control command to the target home electrical appliance.

Since the control command generated in step 102 includes the name of the target home electrical appliance, the target home electrical appliance can be directly determined according to the control command, and the control command can be transmitted to the target home electrical appliance, such that the target home electrical appliance can execute the control command.

Step 104: acquiring a first execution result sent back from the target home electrical appliance, wherein the first execution result represents a state of the target home electrical appliance.

After transmitting the control command to the target home electrical appliance, the first execution result sent back from the target home electrical appliance can be acquired, wherein the first execution result represents the state of the target home electrical appliance. Specifically, the first execution result includes the current operation state of the target home electrical appliance. The mobile terminal can determine whether the target home electrical appliance has successfully executed the control command according to the first execution result. For example, when the control command is “turn on air conditioner”, if the current operation state of the air conditioner in the first execution result is “turn off”, the mobile terminal can determine that the air conditioner has not successfully executed the control command according to the first execution result, and if the current operation state of the air conditioner in the first execution result is “turn on”, the mobile terminal can determine that the air conditioner has successfully executed the control command according to the first execution result. In addition, in step 104, a situation of failing to acquire the first execution result may occur. That is to say, the first execution result sent back from the target home electrical appliance cannot be acquired. In this situation, the first execution result is set, as default, that the target home electrical appliance has not successfully executed the control command. Further optionally, in order to have the process of the voice controlling responding promptly, the mobile terminal can automatically acquire the first execution result of the target home electrical appliance when a time period after the control command is transmitted to the target home electrical appliance reaches a preset time period. For example, in a case that the preset time period is 5 seconds, the mobile terminal can automatically request and acquire the first execution result of the target home electrical appliance when the time period after the control command is transmitted to the target home electrical appliance reaches 5 seconds and then the first execution result has not been received yet.

In the embodiments of the present disclosure, the method for voice controlling the smart home electrical appliance includes: acquiring speech information of the user; performing the recognition on the speech information to acquire the control command; determining the target home electrical appliance according to the control command, and transmitting the control command to the target home electrical appliance; acquiring the first execution result sent back from the target home electrical appliance, wherein the first execution result represents the state of the target home electrical appliance. Therefore, the smart home electrical appliance does not need to install a voice module, thereby reducing the cost of the smart home electrical appliance. The user can control any one of home electrical appliances which connected to a network in the home through the voice command from any one of corners of the home, thereby improving the control efficiency. In addition, the user can obtain the current state of the target home electrical appliance through the acquired first execution result.

### Second Embodiment

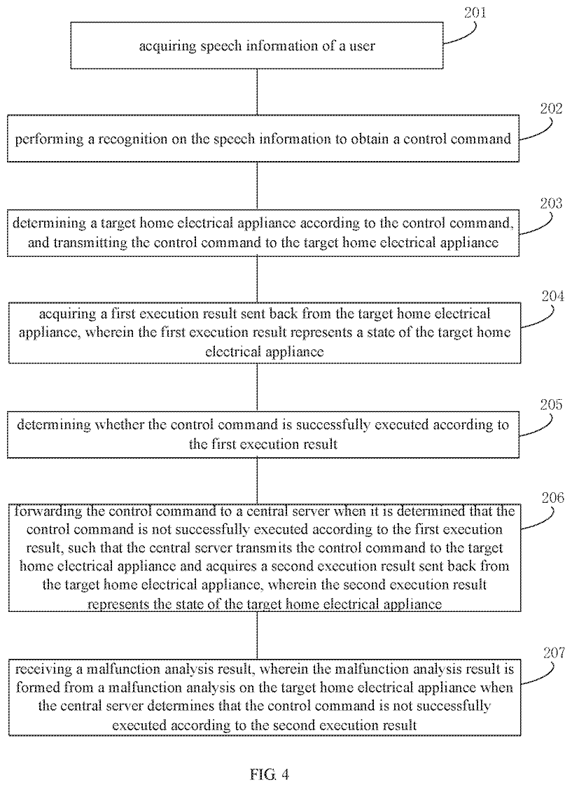

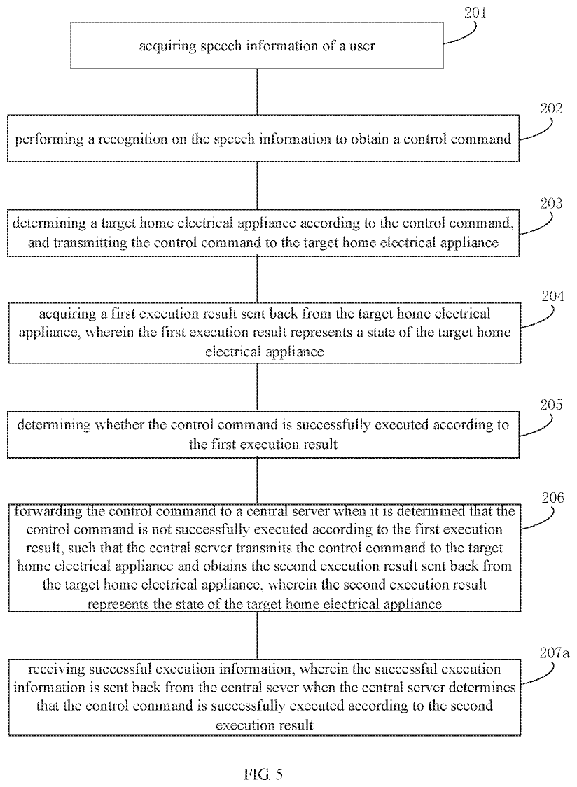

Referring to FIG. 4. in order to solve the above-described technical problem, the second embodiment of the present disclosure provides a method for voice controlling a smart home electrical appliance, including steps 201 to 205.

Step 201: acquiring speech information of a user.

Step 202: performing a recognition on the speech information to acquire a control command.

Step 203: determining a target home electrical appliance according to the control command, and transmitting the control command to the target home electrical appliance.

Step 204: acquiring a first execution result sent back from the target home electrical appliance, wherein the first execution result represents a state of the target home electrical appliance.

The details of steps 201 to 204 are referred to steps 101 to 104 in the first embodiment, and are not repeatedly described herein.

Step 205: determining whether the control command is successfully executed according to the first execution result.

When the first execution result sent back from the target home electrical appliance is acquired, whether the control command is successfully executed will be determined according to the first execution result. The first execution result includes the current operation state of the target home electrical appliance. Specifically, there are three situations to be analyzed. A first situation: the mobile terminal judges and confirms that the target home electrical appliance has not successfully executed the control command according to the first execution result. For example, when the control command is “turn on air conditioner”, if the current operation state of the air conditioner in the first execution result is “turn off”, the mobile terminal can determine that the air conditioner has not successfully executed the control command according to the first execution result. A second situation: the mobile terminal judges and confirms that the target home electrical appliance has successfully executed the control command according to the first execution result. For example, when the control command is “turn on air conditioner”, if the current operation state of the air conditioner in the first execution result is “turn on”, the mobile terminal can determine that the air conditioner has successfully executed the control command according to the first execution result. A third situation: a situation of failing to acquire the first execution result is occur, that is, the first execution result sent back from the target home electrical appliance cannot be acquired. In this situation, the first execution result is set, as default, that the target home electrical appliance has not successfully executed the control command.

In order to further improve the method for voice controlling the smart home electrical appliance and add functions such as feedback, monitoring, and malfunction analysis to the method, the method further includes the following steps 206 to 207:

Step 206: forwarding the control command to a central server when it is determined that the control command is not successfully executed according to the first execution result, such that the central server transmits the control command to the target home electrical appliance and acquires a second execution result sent back from the target home electrical appliance, wherein the second execution result represents the state of the target home electrical appliance.

According to step 205, when the first situation or the third situation occurs, it is determined that the control command is not successfully executed, and the control command is forwarded to the central server, such that the central server transmits the control command to the target home electrical appliance and acquires the second execution result sent back from the target home electrical appliance. It is ensured that the control command can be effectively executed by indirectly controlling the smart home electrical appliance through the central server.

Specifically, the second execution result includes the current operation state of the target home electrical appliance. Once the central server transmits the control command to the target home electrical appliance and acquires the second execution result sent back from the target home electrical appliance, the central server will analyze the second execution result and determine whether the target home electrical appliance has successfully executed the control command. More specifically, the central server can determine whether the target home electrical appliance has successfully executed the control command according to the second execution result. For example, when the control command is “turn on air conditioner”, if the current operation state of the air conditioner in the second execution result is “turn off”, the central server can determine that the air conditioner has not successfully executed the control command according to the second execution result; and if the current operation state of the air conditioner in the second execution result is “turn on”, the central server can determine that the air conditioner has successfully executed the control command according to the second execution result. In addition, in step 206, a situation of failing to acquire the second execution result may occur. That is to say, the second execution result sent back from the target home electrical appliance cannot be acquired. In this situation, the second execution result is set, as default, that the target home electrical appliance has not successfully executed the control command. In some other alternative embodiments, both the mobile terminal and the central server can directly acquire the second execution result sent back from the target home electrical appliance, and can determine whether the target home electrical appliance has successfully executed the control command according to the second execution result sent back from the target home electrical appliance. Further optionally, in order to have the process of the voice controlling responding promptly, the mobile terminal can automatically acquire the second execution result of the target home electrical appliance when a time period after the control command is transmitted to the target home electrical appliance reaches a preset time period. For example, in the case that the preset time is 5 seconds, the mobile terminal may automatically request and acquire the second execution result of the target home electrical appliance when the time period after the control command is transmitted to the target home electrical appliance reaches 5 seconds and then the second execution result has not been received yet.

If the central server determines that the control command is not successfully executed according to the second execution result, the method further includes the following step 207.

Step 207: receiving a malfunction analysis result, wherein the malfunction analysis result is formed from a malfunction analysis on the target home electrical appliance when the central server determines that the control command is not successfully executed according to the second execution result.

After the server acquires the second execution result sent back from the target home electrical appliance, the server will determine whether the control command is successfully executed according to the second execution result. The second execution result includes the current operation state of the target home electrical appliance. Specifically, there are three situations to be analyzed. A first situation: the central server judges and confirms that the target home electrical appliance has not successfully executed the control command according to the second execution result. For example, when the control command is “turn on air conditioner”, if the current operation state of the air conditioner in the second execution result is “turn off”, the central server can determine that the air conditioner has not successfully executed the control command according to the second execution result. A second situation: the central server judges and confirms that the target home electrical appliance has successfully executed the control command according to the second execution result. For example, when the control command is “turn on air conditioner”, if the current operation state of the air conditioner in the second execution result is “turn on”, the central server can determine that the air conditioner has successfully executed the control command according to the second execution result. A third situation: a situation of failing to acquire the second execution result is occur, that is, the second execution result sent back from the target home electrical appliance cannot be acquired. In this situation, the second execution result is set, as default, that the target home electrical appliance has not successfully executed the control command. Of course, in some other alternative embodiments, both the mobile terminal and the central server can directly acquire the second execution result sent back from the target home electrical appliance, and can determine whether the target home electrical appliance has successfully executed the control command according to the second execution result sent back from the target home electrical appliance.

In summary, when the central server determines that the control command has not been successfully executed according to the second execution result, or when the mobile terminal determines that the control command has not been successfully executed according to the second execution result and transmits this information to the central server, the central server performs the malfunction analysis on the target home electrical appliance to form the malfunction analysis result. The central server stores the malfunction analysis result and sends the malfunction analysis result to the mobile terminal. The malfunction analysis result includes a cause and a solution for the malfunction of the target home electrical appliance, so as to remind the user to repair the target home electrical appliance in time.

In order to make the embodiments of the present disclosure more complete, the central server is also configured to intermittently send a specific monitoring instruction to the target home electrical appliance and receive a third execution result send back from the target home electrical appliance, and then determine whether the operation state of the target home electrical appliance is abnormal according to the third execution result. If the operation state of the target home electrical appliance is abnormal, the central server can execute a malfunction analysis program to diagnose the malfunction of the target home electrical appliance, and store and send the possible cause of the malfunction to the mobile terminal, so as to remind the user to repair the appliance in time. The determination ways of the central server can be referred to steps 205 to 207, which are not repeatedly described herein.

Further referring to FIG. 5, if the central server determines that the control command is successfully executed according to the second execution result, the method in the present embodiments does not execute step 207, but executes the following step 207a.

Step 207a: receiving successful execution information, wherein the successful execution information is sent back from the central sever when the central server determines that the control command is successfully executed according to the second execution result.

Referring to the specific description in step 207: the central server determines whether the control command is successfully executed according to the second execution result after receiving the second execution result sent back from the target home electrical appliance. The central server directly sends successful execution information back to the mobile terminal when the central server determines that the control command is successfully executed according to the second execution result, wherein the content of the successful execution information is used for representing the target home electrical appliance has successfully executed the control command.

In the embodiments of the present disclosure, the method for voice controlling the smart home electrical appliance includes: acquiring speech information of the user; performing the recognition on the speech information to acquire the control command; determining the target home electrical appliance according to the control command, and transmitting the control command to the target home electrical appliance; acquiring the first execution result sent back from the target home electrical appliance, wherein the first execution result represents the state of the target home electrical appliance. Therefore, the smart home electrical appliance does not need to install a voice module, thereby reducing the cost of the smart home electrical appliance. The user can control any one of home electrical appliances which connected to a network in the home through the voice command from any one of corners of the home, thereby improving the control efficiency. In addition, the user can obtain the current state of the target home electrical appliance via the acquired first execution result. In addition, the method further determines whether the control command is successfully executed according to the first execution result. If the control command is not successfully executed, the method forwards the control command to the central server, such that the central server transmits the control command to the target home electrical appliance and acquires the second execution result sent back from the target home electrical appliance. If it is determined that the control command is not successfully executed according to the second execution result, the method further receives the malfunction analysis result, the malfunction analysis result is formed from a malfunction analysis on the target home electrical appliance when the central server determines that the control command is not successfully executed according to the second execution result. If the control command is successfully executed according to the second execution result, the method receives the successful execution information. In summary, the embodiments of the present disclosure reduce the cost of the smart home electrical appliance with voice control, expand the control range of the voice control for the smart home electrical appliance, improve the control efficiency, and increase the degree of mastery to the state of the home electrical appliance by the user, thereby improving user experience.

### Third Embodiment

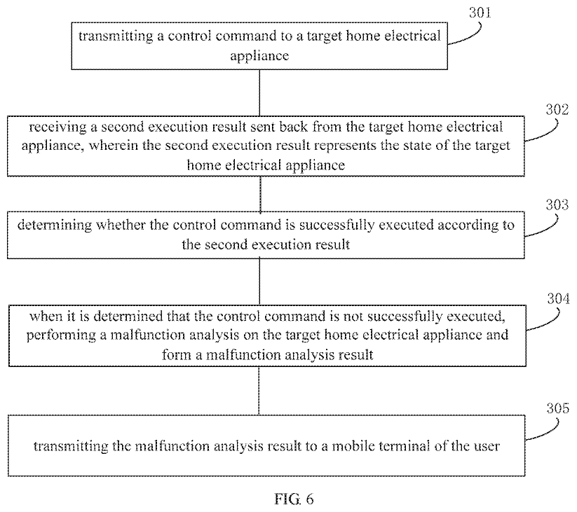

Referring to FIG. 6, in order to solve the above-described technical problems, the third embodiment of the present disclosure provides a method for voice controlling a smart home electrical appliance, including steps 301 to 305.

Step 301: transmitting a control command to a target home electrical appliance.

The central server transmits the control command to the target home electrical appliance, wherein the control command can be forwarded from the mobile terminal to the central server, or can be a monitoring command generated in the central server.

Step 302: receiving a second execution result sent back from the target home electrical appliance, wherein the second execution result represents the state of the target home electrical appliance.

Step 303: determining whether the control command is successfully executed according to the second execution result.

Step 304: when it is determined that the control command is not successfully executed, performing a malfunction analysis on the target home electrical appliance and forming a malfunction analysis result.

Step 305: transmitting the malfunction analysis result to a mobile terminal of the user.

The specific descriptions and beneficial effects for steps 301 to 305 can be referred to steps 206 to 207 in the second embodiment, and details thereof are not repeatedly described herein.

### Fourth Embodiment

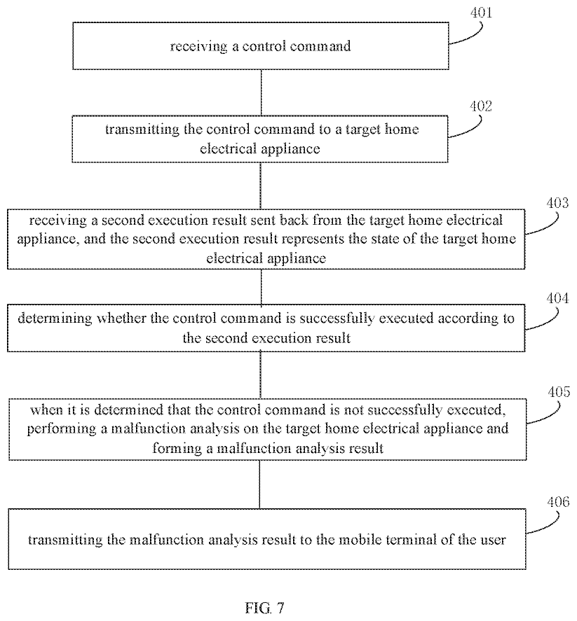

Referring to FIG. 7, in order to solve the above-described technical problem, the fourth embodiment of the present disclosure provides a method for voice controlling a smart home electrical appliance, including steps 401 to 406.

Step 401: receiving a control command.

The received control command is transmitted from the mobile terminal of the user.

Step 402: transmitting the control command to a target home electrical appliance.

The central server transmits the control command to the target home electrical appliance, wherein the control command can be forwarded from the mobile terminal to the central server, or can be a monitoring command generated in the central server.

Step 403: receiving a second execution result sent back from the target home electrical appliance, and the second execution result represents the state of the target home electrical appliance.

Step 404: determining whether the control command is successfully executed according to the second execution result;

Step 405: when it is determined that the control command is not successfully executed, performing a malfunction analysis on the target home electrical appliance and forming a malfunction analysis result.

Step 406: transmitting the malfunction analysis result to the mobile terminal of the user.

When the execution of the control command is determined to be successful, successful execution information is formed and transmitted to the mobile terminal of the user.

The specific descriptions and beneficial effects for steps 403 to 406 in the fourth embodiment can be referred to steps 206, 207, and 207a in the second embodiment, and details thereof are not repeatedly described herein.

### Fifth Embodiment

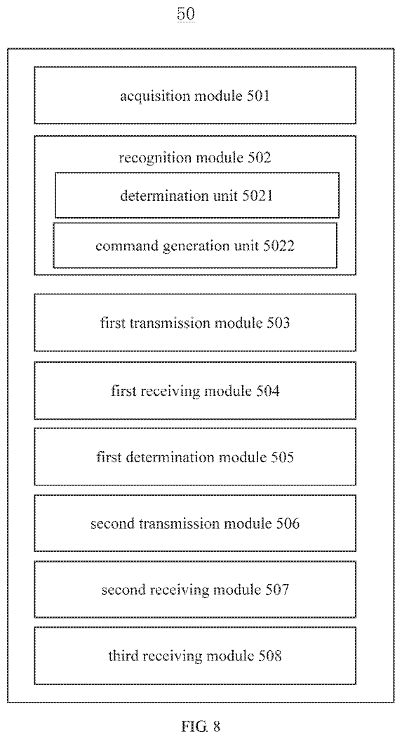

Referring to FIG. 8, in order to solve the above-described technical problem, the fifth embodiment of the present disclosure provides an apparatus 50 for voice controlling a smart home electrical appliance, including: an acquisition module 501, a recognition module 502, a first transmission module 503, a first receiving module 504, a first determination module 505, a second transmission module 506, a second receiving module 507, and a third receiving module 508.

The acquisition module 501 is configured to acquire speech information of a user.

The recognition module 502 is configured to perform a recognition on the speech information to acquire a control command.

The first transmission module 503 is configured to determine a target home electrical appliance according to the control command, and transmit the control command to the target home electrical appliance.

The first receiving module 504 is configured to receive a first execution result sent back from the target home electrical appliance, wherein the first execution result represents a state of the target home electrical appliance.

The first determination module 505 is configured to determine whether the control command is successfully executed according to the first execution result.

The second transmission module 506 is configured to forward the control command to a central server when it is determined that the control command is not successfully executed according to the first execution result, such that the central server transmits the control command to the target home electrical appliance command and receive a second execution result sent back from the target home electrical appliance, wherein the second execution result represents the state of the target home electrical appliance.

The second receiving module 507 is configured to receive a malfunction analysis result, wherein the malfunction analysis result is formed from a malfunction analysis on the target home electrical appliance when the central server determines that the control command is not successfully executed according to the second execution result.

The third receiving module 508 is configured to receive successful execution information, wherein the successful execution information is sent back from the central server when the central server determines that the control command is successfully executed according to the second execution result.

The recognition module 502 includes a determination unit 5021 and a command generation unit 5022.

The determination unit 5021 is configured to perform the recognition on the speech information and determine keyword information in the speech information, wherein the keyword information includes a name of the target home electrical appliance and an action to the target home electrical appliance;

The command generation unit 5022 is configured to generate the control command according to the keyword information.

It should be noted that the mobile terminal 11 of the present disclosure includes the apparatus 50 of the fifth embodiment.

It should be also noted that, as the apparatus in the fifth embodiment and the method in the second embodiment of the present disclosure are based on the same inventive concept, the technical content of the method in the second embodiment is also applicable to the apparatus in the fifth embodiment, therefore, the same technical contents and beneficial effects of the fifth embodiment as that of second embodiment will not be repeatedly described herein.

### Sixth Embodiment

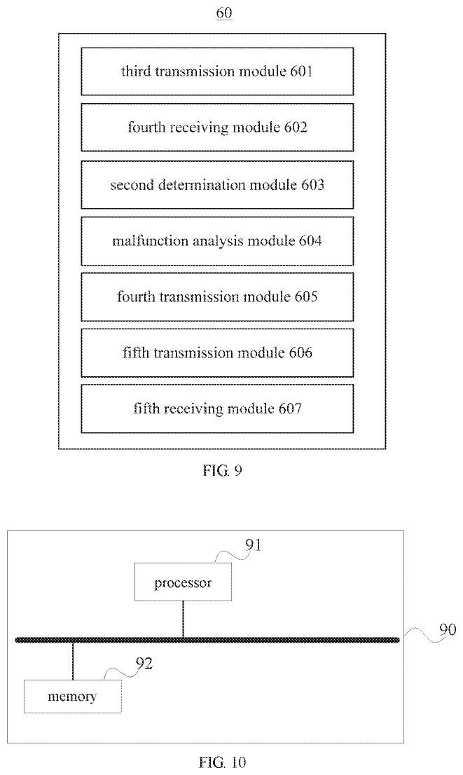

Referring to FIG. 9. in order to solve the above-described technical problem, the sixth embodiment of the present disclosure provides an apparatus 60 for voice controlling a smart home electrical appliance, including: a third transmission module 601, a fourth receiving module 602, a second determination module 603, a malfunction analysis module 604, a fourth transmission module 605, a fifth transmission module 606, and a fifth receiving module 607.

The third transmission module 601 is configured to transmit a control command to a target home electrical appliance.

The fourth receiving module 602 is configured to receive a second execution result sent back from the target home electrical appliance, wherein the second execution result represents a state of the target home electrical appliance.

The second determination module 603 is configured to determine whether the control command is successfully executed according to the second execution result.

The malfunction analysis module 604 is configured to perform a malfunction analysis on the target home electrical appliance and form a malfunction analysis result when it is determined that the control command is not successfully executed.

The fourth transmission module 605 is configured to transmit the malfunction analysis result to a mobile terminal of the user.

The fifth transmission module 606 is configured to form successful execution information and transmit the successful execution information to the mobile terminal of the user when it is determined that the control command is successfully executed.

The fifth receiving module 607 is configured to receive the control command.

It should be noted that the central server 13 of the present disclosure includes the apparatus 60 of the sixth embodiment.

It should be also noted that, as the apparatus in the sixth embodiment and the methods in the third and fourth embodiments are based on the same inventive concept, the specific contents and beneficial effects of the sixth embodiment can be referred to the third embodiment and the fourth embodiment, and will not be repeatedly described herein.

It should be further noted that, as the apparatus in the sixth embodiment and the method in the fourth embodiment of the present disclosure are based on the same inventive concept, the technical content of the method in the fourth embodiment is also applicable to the apparatus of the sixth embodiment, therefore, the same technical contents and beneficial effects of the sixth embodiment as that of fourth embodiment will not be repeatedly described herein.

### Seven Embodiment

Referring to FIG. 1 again, in order to solve the above-described technical problem, the seventh embodiment of the present disclosure provides a system for voice controlling a smart home electrical appliance. The system includes a mobile terminal 11, a smart home electrical appliance 12, and a central server 13. The mobile terminal 11 is connected to the smart home electrical appliance 12. The central server 13 is respectively connected to the mobile terminal 11 and the smart home electrical appliance 12.

The mobile terminal 11 is configured to acquire speech information of a user, perform a recognition on the speech information to acquire a control command, determine a target home electrical appliance from the smart home electrical appliance according to the control command, and transmit the control command to the target home electrical appliance. The mobile terminal 11 is further configured to acquire a first execution result sent back from the target home electrical appliance, wherein the first execution result represents a state of the target home electrical appliance. Optionally, the performing the recognition on the speech information to acquire the control command includes: performing the recognition on the speech information to determine keyword information in the speech information, wherein the keyword information includes a name of the target home electrical appliance and an action to the target home electrical appliance; and generating the control command according to the keyword information.

Optionally, the mobile terminal 11 is further configured to determine whether the control command is successfully executed according to the first execution result.

When it is determined that the control command is not successfully executed according to the first execution result, the control command is forwarded to the central server 13, such that the central server 13 transmits the control command to the target home electrical appliance and acquires the second execution result sent back from the target home electrical appliance. The second execution result represents a state of the target home electrical appliance.

Optionally, the central server 13 is configured to determine whether the control command is successfully executed according to the second execution result. When it is determined that the control command is not successfully executed according to the second execution result, the central server 13 perform a malfunction analysis on the target home electrical appliance to form a malfunction analysis result.

The mobile terminal 11 is further configured to receive the malfunction analysis result.

Optionally, the central server 13 is configured to determine whether the control command is successfully executed according to the second execution result. When it is determined that the control command is successfully executed according to the second execution result, the central server 13 send a successful execution information back to the mobile terminal 11.

The mobile terminal 11 is further configured to receive the successful execution information.

Optionally, the central server 13 is configured to store information of each smart home electrical appliance 12, and the information of the smart home electrical appliance 12 includes the name of the smart home electrical appliance 12.

The mobile terminal 11 is further configured to acquire information of each smart home electrical appliance 12 stored in the central server 13.

In order to make the embodiments of the present disclosure more complete, the central server 13 is further configured to intermittently send a specific monitoring instruction to the target home electrical appliance and receive a third execution result send back from the target home electrical appliance, and then determine whether the operation state of the target home electrical appliance is abnormal according to the third execution result. If the operation state of the target home electrical appliance is abnormal, the central server will execute a malfunction analysis program to diagnose the malfunction of the target home electrical appliance, and store and send the possible cause of the malfunction to mobile terminal 11, so as to remind the user to repair the target home electrical appliance in time.

It should be noted that the system in the seventh embodiment and the methods in the first and second embodiments are based on the same concept, and the specific content of the system in the seventh embodiment can be referred to the descriptions for the methods in the first and second embodiments of the present disclosure, and is not repeatedly described herein.

Referring to FIG. 10, FIG. 10 is a schematic structural view of a hardware of an electronic device provided in some embodiments of the present disclosure. As shown in FIG. 10, the electronic device 90 includes one or more processors 91 and a memory 92. FIG. 10 takes one processor 91 as an example. The processor 91 and the memory 92 can be connected via a bus or other manners. FIG. 10 takes a bus connection as an example.

The memory 92, as a non-volatile computer-readable storage medium, is capable of storing non-volatile software programs, non-volatile computer-executable programs, and modules, such as the program instructions/modules corresponding to the method for voice controlling the smart home electrical appliance in the embodiments of the present disclosure. For example, the modules may be the acquisition module 501, the recognition module 502, and the first transmission module 503 shown in FIG. 8. The processor 91 executes various functional disclosures and data processing of the server through running the non-volatile software programs, instructions, and modules stored in the memory 92, that is, implementing the methods in the above-described method embodiments.

The memory 92 can include a program storage area and a data storage area. The program storage area can store an operating system and at least one functional disclosure. The data storage area can store data created in use of the apparatus for voice controlling the smart home electrical appliance. In addition, the memory 92 can include a high-speed random access memory, and can also include a non-volatile memory, such as at least one of a disk memory, a flash memory, or other non-volatile solid-state memory. In some embodiments, the memory 92 can optionally include memories remotely arranged with respect to the processor 91, and these remote memories can be connected to the apparatus for the voice controlling the smart home electrical appliance through a network. The above-mentioned examples of the network include, but are not limited to, the Internet, an intranet, a local area network, a mobile communication network, and combinations thereof.

The one or more modules are stored in the memory 92. The one or more modules implement the method for voice controlling the smart home electrical appliance in any one of the method embodiments while being executed by the one or more processors 91, for example, implement the step 101 to the step 104 in the method shown in FIG. 2, the step 1021 to the step 1022 in the method shown in FIG. 3, the step 201 to the step 207 in the method shown in FIG. 4, the step 201 to the step 207a in the method shown in FIG. 5, the step 301 to the step 305 in the method shown in FIG. 6, the step 401 to the step 406 in the method shown in FIG. 7, and realize the functions in the module 501 to the module 508 shown in FIG. 8, and the functions in the module 601 to the module 607 shown in FIG. 9.

The above-mentioned products can execute the methods provided in the embodiments of the present disclosure, and have corresponding functional modules and beneficial effects for executing the methods. For technical details that are not described in detail in this embodiment, reference can be made to the method provided in the embodiments of the present disclosure.

The electronic device in the embodiments of the present disclosure has various forms, including but not limited to a server or a device that provides computing services, or other electronic devices with data interaction functions. The architecture of the server includes a processor, a hard disk, a memory, a system bus, and so on. The architecture of server is similar to that of a universal computer, but has higher requirements in processing ability, stability, reliability, security, extensibility, and manageability because it needs to provide high reliable services.

Some embodiments of the present disclosure provide a non-volatile computer-readable storage medium. The non-volatile computer-readable storage medium stores computer-executable instructions which implement the method for voice controlling the smart home electrical appliance in any one of the above-described method embodiments while being executed by the electronic device, for example, implement the step 101 to the step 104 in the method shown in FIG. 2, the step 1021 to the step 1022 in the method shown in FIG. 3, the step 201 to the step 207 in the method shown in FIG. 4, the step 201 to the step 207a in the method shown in FIG. 5, the step 301 to the step 305 in the method shown in FIG. 6, the step 401 to the step 406 in the method shown in FIG. 7, and realize the functions in the module 501 to the module 508 shown in FIG. 8, and the functions in the module 601 to the module 607 shown in FIG. 9.

Some embodiments of the present disclosure provides a computer program product including a computing program stored on a non-volatile computer-readable storage medium. The computer program includes program instructions which implement the method for voice controlling the smart home electrical appliance according to any one of the above-described method embodiments while being executed, for example, implement the step 101 to the step 104 in the method shown in FIG. 2, the step 1021 to the step 1022 in the method shown in FIG. 3, the step 201 to the step 207 in the method shown in FIG. 4, the step 201 to the step 207a in the method shown in FIG. 5, the step 301 to the step 305 in the method shown in FIG. 6, the step 401 to the step 406 in the method shown in FIG. 7, and realize the functions in the module 501 to the module 508 shown in FIG. 8, and the functions in the module 601 to the module 607 shown in FIG. 9.

Through the description of the above embodiments, those skilled in the art can clearly understand that the embodiments can be implemented by software with a general hardware platform, and of course, can also be implemented by hardware. One of ordinary skill in the art can understand that entire or part of the processes in the method of the embodiments can be accomplished by using a computer program to instruct related hardware. The program can be stored in a computer-readable storage medium. When executed, the processes can include the embodiments of the methods. The storage medium can be a magnetic disk, an optical disk, a read-only memory (ROM), or a random access memory (RAM).

The above descriptions are only embodiments of the present disclosure, and do not limit the patent scope of the present disclosure. Any equivalent structure or equivalent process using the contents of the descriptions and drawings of the disclosure, or directly or indirectly disclosure of the contents of the descriptions and drawings of the disclosure in other related technologies are all covered by the patent protection scope of this disclosure.

1. A method for voice controlling a smart home electrical appliance, comprising:
acquiring speech information of a user;
performing a recognition on the speech information to acquire a control command;
determining a target home electrical appliance according to the control command, and transmitting the control command to the target home electrical appliance; and
receiving a first execution result sent back from the target home electrical appliance, wherein the first execution result represents a state of the target home electrical appliance.

2. The method of claim 1, further comprising:
determining whether the control command is successfully executed according to the first execution result; and
forwarding the control command to a central server when it is determined that the control command is not successfully executed according to the first execution result, such that the central server transmits the control command to the target home electrical appliance and receives a second execution result sent back from the target home electrical appliance, wherein the second execution result represents the state of the target home electrical appliance.

3. The method of claim 2, further comprising:
receiving a malfunction analysis result, wherein the malfunction analysis result is formed from a malfunction analysis on the target home electrical appliance when the central server determines that the control command is not successfully executed according to the second execution result.

4. The method of claim 2, further comprising:
receiving successful execution information, wherein the successful execution information is sent back from the central server when the central server determines that the control command is successfully executed according to the second execution result.

5. The method of claim 1, wherein the performing the recognition on the speech information to acquire the control command comprises:
performing the recognition on the speech information to determine keyword information in the speech information, wherein the keyword information comprises a name of the target home electrical appliance and an action to the target home electrical appliance; and
generating the control command according to the keyword information.

6. A method for voice controlling a smart home electrical appliance, comprising:
transmitting a control command to a target home electrical appliance;
receiving a second execution result sent back from the target home electrical appliance, wherein the second execution result represents a state of the target home electrical appliance;
determining whether the control command is successfully executed according to the second execution result;
when it is determined that the control command is not successfully executed, performing a malfunction analysis on the target home electrical appliance and forming a malfunction analysis result; and
transmitting the malfunction analysis result to a mobile terminal.

7. The method of claim 6 further comprising:
when it is determined that the control command is successfully executed, forming successful execution information and transmitting the successful execution information to the mobile terminal.

8. The method of claim 6, prior to the transmitting the control command to the target home electrical appliance, further comprising:
receiving the control command.

9-16. (canceled)

17. An electronic device, characterized by comprising:
at least one processor; and
a memory connected to the at least one processor, wherein the memory storing operation instructions configured to be executed by the at least one processor, and the processor executes the method of claim 1 while the operation instructions being executed.

18. A system for voice controlling a smart home electrical appliance, comprising: a mobile terminal, the smart home electrical appliance, and a central server, wherein the mobile terminal is connected to the smart home electrical appliance, and the central server is respectively connected to the mobile terminal and the smart home electrical appliance;
the mobile terminal is configured to:
acquire speech information of a user;
perform a recognition on the speech information to acquire a control command;
determine a target home electrical appliance from the smart home electrical appliance according to the control command;
transmit the control command to the target home electrical appliance;
acquire a first execution result sent back from the target home electrical appliance, the first execution result representing a state of the target home electrical appliance;
determine whether the control command is successfully executed according to the first execution result; and
forward the control command to the central server when it is determined that the control command is not successfully executed according to the first execution result;
the central server is configured to:
transmit the control command to the target home electrical appliance and acquire a second execution result sent back from the target home electrical appliance, the second execution result representing the state of the target home electrical appliance;
determine whether the control command is successfully executed according to the second execution result;
perform a malfunction analysis on the target home electrical appliance and form a malfunction analysis result, and then transmit the malfunction analysis result to the mobile terminal when it is determined that the control command is not successfully executed according to the second execution result; and
send successful execution information back to the mobile terminal when it is determined that the execution of the control command is successful according to the second execution result.

19. The system of claim 18, wherein the mobile terminal is further configured to receive the malfunction analysis result.

20. The system of claim 18, wherein the mobile terminal is further configured to receive the successful execution information.

21. The system of claim 18, wherein the mobile terminal is further configured to acquire information of each smart home electrical appliance stored in the central server, and the information of the each smart home electrical appliance comprises a name of the each smart home electrical appliance.

22. The system of claim 18, wherein the mobile terminal is configured to perform the recognition on the speech information to acquire the control command by:
performing the recognition on the speech information to determine keyword information in the speech information, wherein the keyword information comprises a name of the target home electrical appliance and an action to the target home electrical appliance; and
generating the control command according to the keyword information.

23. The system of claim 18, wherein the central server is further configured to receive the control command.

24. The method of claim 1, further comprising:
acquiring information of each smart home electrical appliance stored in the central server, wherein the information of the each smart home electrical appliance comprises a name of the each smart home electrical appliance.

25. An electronic device, characterized by comprising:
at least one processor; and
a memory connected to the at least one processor, wherein the memory storing operation instructions configured to be executed by the at least one processor, and the processor executes the method of claim 6 while the operation instructions being executed.
